(19) United States
(12) Patent Application Publication
(10) Pub. No.: US 2018/0241028 A1
(43) Pub. Date: Aug. 23, 2018

(54) LITHIUM ION BATTERY SYSTEM HAVING TEMPERATURE CONTROL FUNCTION

(71) Applicants: Bordrin Motor Corporation, Inc., Southfield, MI (US); Huai'an Junsheng New Energy Technology Co., Ltd., Huai'an City (CN); Nanjing Shenghe New Energy Technology Co., Ltd., Nanjing City (CN)

(72) Inventors: Zhongjun Chen, Huaiyang County (CN); Zhiwei Zhang, Shanghai (CN)

(21) Appl. No.: 15/699,075

(22) Filed: Sep. 8, 2017

(30) Foreign Application Priority Data
Feb. 22, 2017 (CN) 201720159465.0

(51) Int. Cl. H01M 2/34; H01M 10/0525; H01M 10/613; H01M 10/625

(52) U.S. Cl. CPC H01M 2/348; H01M 10/0525; H01M 2220/20; H01M 10/625; H01M 10/613

(57) ABSTRACT

A lithium ion battery system having a temperature control function includes a shell, a battery core, and a phase change material. The battery core is packaged in the shell, the shell is filled with the phase change material which is in contact with a surface of the battery core, and the phase change material includes sodium nitrate with crystal water, paraffin wax, white carbon black, polyacrylamide gel, and trimethylolpropane.

### PRIORITY CLAIM

This application claims priority to Chinese Patent Application No. 201720159465.0, filed on Feb. 22, 2017, the contents of which is hereby incorporated by reference in its entirety.

### BACKGROUND

### 1. Field of the Invention

The present invention generally relates to the field of automobile body structures, and in particular, to a lithium ion battery system having a temperature control function.

### 2. Description of Related Art

Automobiles have become indispensable transportation tools for people to travel. Development of conventional automobiles causes some problems such as pollution of the environment from automobile emissions and excessive consumption of petroleum resources. As compared with the conventional automobiles, purely electric vehicles have no emission, do not consume petroleum, and are considered by many to be the future of the automobile. A battery system is a core part of an electric vehicle and is formed by connecting many battery cells in series or in parallel.

The working conditions of an electric vehicle when traveling are complex. A battery generates a relatively significant amount of heat when in use. As a result, the internal temperature of the battery increases rapidly. If the heat cannot be released or absorbed timely, the electrical and thermal characteristics of the cells of the battery may become inconsistent, the service life of the battery is reduced acutely, and even potential safety hazards are possible.

Additionally, electric vehicles generally are subject to frequent acceleration and deceleration, and travels in different geographical regions, in which working conditions for travel are complex, and ambient temperatures vary greatly. An excessively low temperature of a battery will cause a reduction in the activity of an electrolyte and an increase in the internal resistance, and consequently, the battery cannot be used. An excessively high temperature of a battery will cause performance of a lithium ion battery to degrade, which will cause a reduction in the cycle life of the battery and increases a probability of thermal runaway. These thermal problems interfere with customer experience, energy density improvement of a battery cell, quick charging, high-rate discharging, improvement of waterproof level, and the like. Therefore, it is critical to implement heat management on the lithium battery.

There are several developing methodologies for solving the heat problem of a lithium battery. One prior art solution involves monitoring a temperature of a lithium battery with a battery management system (BMS) of an automobile. The BMS system provides an alarm when the temperature exceeds a threshold and stops the lithium battery from operating further. In this method, the BMS system needs to perform many calculations, resulting in costly and complex implementation.

Another prior art methodology involves filling a battery on the side of an automobile with a phase change material, so as to implement temperature control on the lithium battery by utilizing characteristics of the phase change material. Such a manner is simple and cost-saving. However, existing phase change materials developed for other purposes are mostly used without considering the particularity of usage of such materials in a vehicle battery. Therefore, a temperature control effect that can be achieved is modest, and safety performance is poor.

### SUMMARY

A lithium ion battery system having a temperature control function includes a shell, a battery core and a phase change material. The battery core is packaged in the shell, the shell is filled with the phase change material which is in contact with a surface of the battery core, and the phase change material includes sodium nitrate with crystal water, paraffin wax, white carbon black, polyacrylamide gel, and trimethylolpropane.

The shell may include a metal box with an opening on one end and an upper cover, the upper cover is provided with a buckle, the metal box is provided with a boss, and the upper cover and the metal box are connected by means of the buckle and the boss. The metal box may be an aluminum alloy metal box.

The upper cover may further include an anti-explosion valve. The upper cover may include a pole lug through hole for the battery core to pass through. The upper cover may be made of plastic. The plastic may include polypropylene, ABS plastic, and carbon fiber.

The battery core may include a lithium ion battery cell or a lithium ion battery parallel core. The lithium ion battery parallel core may include at least two lithium ion battery cells and heat conducting silica gel, and the lithium ion battery cells are connected to each other in parallel, and are adhered to each other by using the heat conducting silica gel.

As compared with the prior art, the lithium ion battery system described herein has the following beneficial effects:

First, an interior of a shell may be filled with a phase change material including sodium nitrate with crystal water, paraffin wax, white carbon black, polyacrylamide gel, and trimethylolpropane. Because white carbon black is added into the phase change material, the phase change material is in a solid state and is unlikely to leak. Such a phase change material can prolong a service life of a battery, so that temperature distribution of the battery is uniform, efficiency is high, and a cooling effect is good. Meanwhile, such a phase change material has flame retardance and high elasticity, and thus can form anti-impact protection for the battery, prevent thermal runaway of single battery from affecting the whole battery system, and form a safety barrier.

Second, the shell may include a metal box with an opening on one end and an upper cover. The metal box and the upper cover are connected by means of a buckle and a boss. Such a sealing manner, on the one hand, can ensure tightness of the sealing, and on the other hand, is also convenient for disassembly and assembly, as well as filling of the phase change material and inspection on the battery.

Third, the upper cover may be provided with an anti-explosion valve to prevent a fault caused by an excessive high temperature of the battery when the temperature exceeds a regulation range of the phase change material, thereby improving safety performance of the battery system.

Fourth, the metal box may be an aluminum alloy metal box, which has better heat conductivity and is convenient for the battery system to dissipate heat to the outside.

Fifth, the upper cover may include a pole lug through hole for the battery core to pass through, two poles of the battery can be connected to the outside to supply power without opening the upper cover. The design is convenient, and convenience is enhanced.

Sixth, the upper cover may be made of plastic including polypropylene, ABS plastic, and carbon fiber, and has a light weight, high strength, and good stability, so that not only the weight of the shell is reduced, but also firmness of the shell is ensured.

Seventh, a lithium ion battery cell or a parallel lithium ion battery core can be selected as the battery core according to actual requirements. Practicability is high, and selection is flexible.

Eight, the lithium ion batteries may be connected in parallel are adhered to each other by means of heat conducting silica gel, so as to facilitate heat exchange among respective lithium ion battery cells, so that the whole battery system is heated uniformly, temperature consistency of the batteries is relatively good, and accidents caused by an excessively high temperature of a single battery is avoided.

Finally, respective parts of the whole battery system may all be easily machined and have low prices, thereby greatly saving manufacturing costs of the battery system.

Further objects, features, and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 is a schematic structural diagram of the lithium ion battery system;

FIG. 2 is a schematic diagram of a metal box for the lithium ion battery system;

FIG. 3 is a schematic diagram of an upper cover for the lithium ion battery system;

FIG. 4 is a schematic diagram of a lithium ion battery cell for the lithium ion battery system; and

FIG. 5 is a schematic diagram of a lithium ion battery parallel core for the lithium ion battery system; and

FIG. 6 is a diagram of curves of temperature variation of the lithium ion battery system having a temperature control function and a traditional lithium-ion battery system.

### DETAILED DESCRIPTION

The lithium ion battery system is described below in detail with reference to drawings and specific embodiments. The embodiments are implemented by taking a technical solution of the lithium ion battery system described herein. Although detailed implementation manners and specific operation processes are provided, the protection scope of the lithium ion battery system described herein is not limited to the embodiments below.

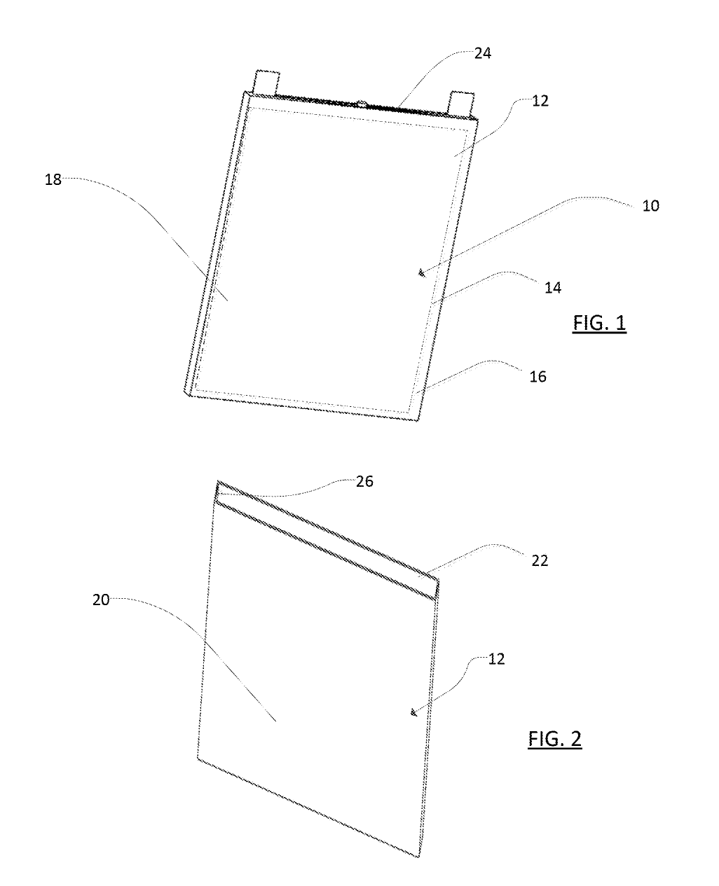

As shown in FIG. 1, a lithium ion battery system 10 having a temperature control function is shown. The lithium ion battery system 10 includes a shell 12, a battery core 14 (located within the shell 12 as indicated by dashed lines), and a phase change material 16 (located within the shell 12). The battery core 14 is packaged in the shell 12. The shell 12 is filled with the phase change material 16 which is in contact with a surface of the battery core 18. The phase change material 16 includes sodium nitrate with crystal water, paraffin wax, white carbon black, polyacrylamide gel, and trimethylolpropane. Sodium nitrate with crystal water accounts for approximately 20%, paraffin wax accounts for approximately 30%, white carbon black accounts for approximately 10%, polyacrylamide gel accounts for approximately 5%, and trimethylol propane accounts for approximately 35% in weight. The phase change material 16 has sealing, insulating, vibration reducing, and flame retarding characteristics, and the phase change material 16 is changeable in shape and presents a stagnant sticky state.

Referring to FIGS. 1 and 2, the shell 12 includes a metal box 20 with an opening 22. The opening 22 is configured to receive the battery core 14 and the phase change material 16. Once the battery core 14 and the phase change material 16 is placed within the metal box 20, an upper cover 24 is then placed over the opening 22 thereby sealing the battery core 14 and the phase change material 16 within the metal box 20. The metal box 20 may include at least one boss 26 which, as explained later, will interact with a snap of the upper cover 24 thereby securely attaching the upper cover 24 to the metal box 20.

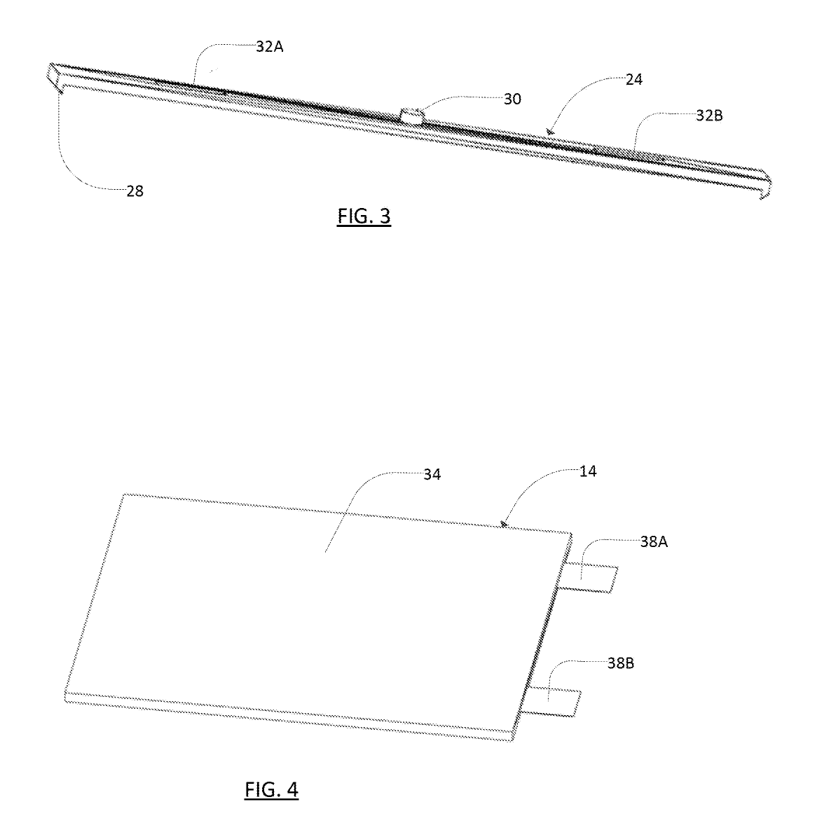

Referring to FIG. 3, a more detailed view of the upper cover 24 is shown. Here, on at least one end of an upper cover 24, the upper cover is provided with a snap 28. As stated previously, the metal box 20 is provided with a boss 26 which is configured to interact with the snap 28 so as to securely attach the upper cover 24 to the metal box 20, the ceiling the battery core 14 and the phase change material 16 within the metal box 20.

The upper cover is further provided with an anti-explosion valve 30. The metal box 20 may be an aluminum alloy metal box. The upper cover 24 is further provided pole lug through holes 32A and 32B for terminals of the battery core 14 to pass through. The upper cover 24 may be made of plastic, and the plastic includes polypropylene, ABS plastic, and carbon fiber.

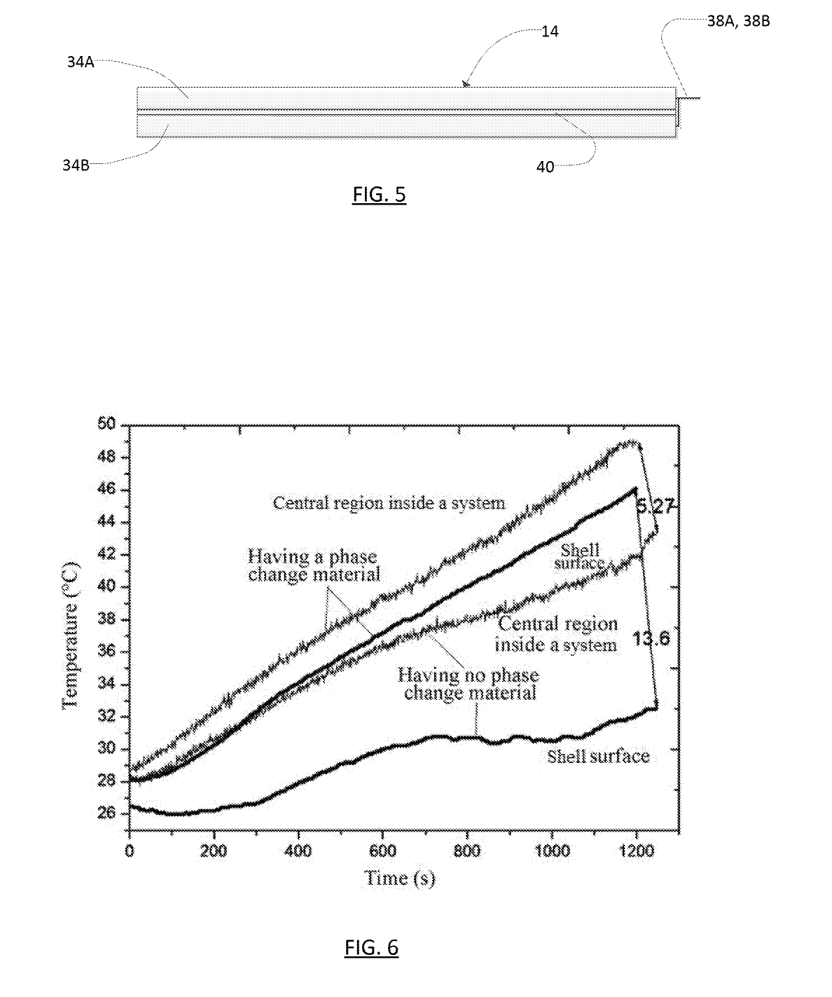

Referring to FIGS. 4 and 5, a more detailed view of the battery core 14 is provided. FIG. 4 illustrates a situation where the battery core 14 is a lithium-ion battery cell 34. Here, the battery core 14 includes battery cell 34 and terminals 38A and 38B extending therefrom. When placed in the metal box 20 and covered with the upper cover 24, the terminals 38A and 38B will protrude through the pole lug through holes 32A and 32B.

As best shown in FIG. 5, battery core 14 in this example includes two separate battery cells 34A and 34B to form a lithium ion battery parallel core. Between the two separate battery cells 34A and 34B is a heat conducting silica gel 40. The lithium ion battery cells 34A and 34B are connected to each other in parallel and are adhered to each other by using the heat conducting silica gel 40. Additionally, the battery core 14 of FIG. 5, like that of FIG. 4, also has two terminals 38A and 38B will protrude through the pole lug through holes 32A and 32B.

The schematic diagrams of respective parts of the battery system 10 are as shown in FIG. 2 to FIG. 5, from which it can be known that the upper cover 24 and the metal box 20 are connected by means of the snap 28 and the boss 26. The phase change material is added into the metal box through the opening of the metal box. The phase change material 16 is in direct contact with the battery core 14. When the battery system 10 is assembled, the battery core 14 is horizontally placed as a cell 34 or a stacked parallel core 34A and 34B. The lithium ion battery cells 34A and 34B are adhered to each other by using the heat conducting silica gel 40 to form a parallel battery system. The lithium ion battery cell 14 or the lithium ion battery parallel core 14 is mounted into the metal box, and two pole lugs 32A and 32B face the outside.

The phase change material 16 is heated into a temperature above a phase change temperature to present a half-flowing state. The phase change material 16 is filled into the metal box 20 and is in close contact with a surface of the battery core 14. Finally, the upper cover 24 is covered on the opening 22 of the metal box 20, the pole lugs pass 32A and 32B through the pole lug through holes 32A and 32B in the upper cover 24. The upper cover 24 is connected to the metal box 20 by means of the snap 28, and then the battery system 10 is completely assembled.

The lithium ion battery system 10 having a temperature control function is manufactured according to the foregoing method, and comparative tests are performed on the lithium ion battery system having a temperature control function and a similar lithium ion battery system without being filled with a phase change material, so as to detect performance of the lithium ion battery system 10 having a temperature control function. A specific process includes the following: first, placing temperature probes at central positions in the middle of battery cores and outside metal boxes of battery modules; then, charging and discharging the two systems (charging at 1 C and discharging at 3 C), and recording temperature changes in a pending state after the discharging and the discharging is ended, where results are as shown in the following table and FIG. 6:

TABLE 1
Impacts of having a phase change material or having no phase
change material on stability of a battery system:

| | Battery core interior | | | Shell surface | | |
|---|---|---|---|---|---|---|
| | | Temperature | | | Temperature | |
| | Temperature | rise rate | Highest | Temperature | rise rate | Highest |
| | rise (° C.) | (° C./s) | temperature | rise (° C.) | (° C./s) | temperature |
| Having | 20.26 | 0.017 | 48.89 | 18 | 0.015 | 46.1 |
| a phase | | | | | | |
| change | | | | | | |
| material | | | | | | |
| Having | 15.54 | 0.012 | 43.62 | 6 | 0.005 | 32.5 |
| no | | | | | | |
| phase | | | | | | |
| change | | | | | | |
| material | | | | | | |

From Table 1 and FIG. 6, it can be seen that an internal temperature can be reduced if the battery core 14 is filled with the phase change material 16. After the phase change material 16 is added, heat is stored in the phase change material 16, and a temperature rise of a module shell 12 is not obvious, so that a quick rise of the internal temperature of the system 10 can be avoided when the battery works at a large current, and the battery can be kept in optimal working condition.

As a person skilled in the art will readily appreciate, the above description is meant as an illustration of the principles of this invention. This description is not intended to limit the scope or application of this invention in that the invention is susceptible to modification, variation and change, without departing from spirit of this invention, as defined in the following claims.

1. A lithium ion battery system having a temperature control function, the lithium ion battery system comprising:
a shell;
a battery core;
a phase change material;
wherein the battery core is packaged in the shell, the shell is filled with the phase change material which is in contact with a surface of the battery core;
the phase change material comprises sodium nitrate with crystal water, paraffin wax, white carbon black, polyacrylamide gel and trimethylolpropane; and
wherein sodium nitrate with crystal water accounts for approximately 20% of the weight of the phase change material, paraffin wax accounts for approximately 30% of the weight of the phase change material, white carbon black accounts for approximately 10% of the weight of the phase change material, polyacrylamide gel accounts for approximately 5% of the weight of the phase change material and trimethylol propane accounts for approximately 35% of the weight of the phase change material.

2. The lithium ion battery system having a temperature control function according to claim 1, wherein the shell comprises a metal box with an opening on one end and an upper cover, the upper cover comprises a buckle, the metal box is provided with a boss, and the upper cover and the metal box are connected by means of the buckle and the boss.

3. The lithium ion battery system having a temperature control function according to claim 2, wherein the upper cover further comprises an anti-explosion valve.

4. The lithium ion battery system having a temperature control function according to claim 2, wherein the metal box is an aluminum alloy metal box.

5. The lithium ion battery system having a temperature control function according to claim 2, wherein the upper cover comprises a pole lug through hole for an electrode terminal of the battery core to pass through.

6. The lithium ion battery system having a temperature control function according to claim 2, wherein the upper cover is made of a plastic, wherein the plastic comprises polypropylene, ABS plastic, and carbon fiber.

7. The lithium ion battery system having a temperature control function according to claim 1, wherein the battery core comprises a lithium ion battery cell or a lithium ion battery parallel core.

8. The lithium ion battery system having a temperature control function according to claim 7, wherein the lithium ion battery parallel core comprises:
at least two lithium ion battery cells;
a heat conducting silica gel;
wherein the lithium ion battery cells are connected to each other in parallel and are adhered to each other by using the heat conducting silica gel.
